(19) United States
(12) Patent Application Publication
(10) Pub. No.: US 2013/0275220 A1
(43) Pub. Date: Oct. 17, 2013

(54) METHOD AND SYSTEM FOR ADVERTISING

(71) Applicant: ONROUTE DIGITAL MEDIA, LLC, Syracuse, NY (US)

(72) Inventors: Noel Anthony Bonk, Brewerton, NY (US); Shane Scott Bogardus, Chittenango, NY (US)

(21) Appl. No.: 13/862,331

(22) Filed: Apr. 12, 2013

Related U.S. Application Data
(60) Provisional application No. 61/798,183, filed on Mar. 15, 2013.
(60) Provisional application No. 61/623,826, filed on Apr. 13, 2012.

(51) Int. Cl. G06Q 30/02

(52) U.S. Cl. CPC G06Q 30/0261
USPC 705/14.58

(57) ABSTRACT

A method and system for advertising is disclosed, wherein an advertisement vendor is assigned an electronically defined geographic advertising area in which advertisement messages will be electronically delivered by the advertising system to mobile digital devices. The advertisement vendor creates an advertising campaign for an advertiser located in the electronically defined geographic advertising area and electronically associates an advertisement message with that advertising campaign. The advertisement message for that advertising campaign is electronically delivered from the advertising system to a mobile digital device when that mobile digital device is located in the electronically defined geographic advertising area and the advertising campaign satisfies the preferences of the user for receiving advertisement messages, including a distance between the mobile digital device and the location of the advertiser.

### CROSS-REFERENCE TO RELATED APPLICATIONS (IF NECESSARY)

This application claims the benefit of and priority to U.S. Provisional Patent Application Ser. No. 61/798,183, filed Mar. 15, 2013, and entitled “SYSTEM AND METHOD FOR ADVERTISING,” the entirety of which is incorporated herein by reference. This application also claims the benefit of and priority to U.S. Provisional Patent Application Ser. No. 61/623,826, filed Apr. 13, 2012, and entitled “SYSTEM AND METHOD FOR ADVERTISING,” the entirety of which is incorporated herein by reference.

### BACKGROUND OF THE INVENTION

The subject matter disclosed herein relates to a method and system for advertising.

Prior to the development of the Internet and the increased use of mobile digital devices, broadcast media outlets (e.g., television and radio stations) and print publishers were the primary providers of advertisements to consumers. These entities now have significant competition from online providers of digital advertising on the Internet (e.g., search engines and other websites) for advertising dollars from the advertising clients. While broadcast media outlets and print publishers have attempted to provide digital advertising to their subscribers on the Internet through their websites and the use of mobile applications, there is still a need for improved methods and systems for these entities to offer more targeted advertisements to their subscribers for advertising clients.

The discussion above is merely provided for general background information and is not intended to be used as an aid in determining the scope of the claimed subject matter.

### BRIEF DESCRIPTION OF THE INVENTION

A method and system for advertising is disclosed, wherein an advertisement vendor is assigned an electronically defined geographic advertising area in which advertisement messages will be electronically delivered by the advertising system to mobile digital devices. The advertisement vendor creates an advertising campaign for an advertiser located in the electronically defined geographic advertising area and electronically associates an advertisement message with that advertising campaign. The advertisement message for that advertising campaign is electronically delivered from the advertising system to a mobile digital device when that mobile digital device is located in the electronically defined geographic advertising area and the advertising campaign satisfies the preferences of the user for receiving advertisement messages, including a distance between the mobile digital device and the location of the advertiser.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a block diagram of an exemplary advertising system;

FIG. 2 is a flow diagram illustrating an exemplary method for identifying an advertisement vendor in the exemplary advertising system of FIG. 1;

FIG. 3 is an exemplary display screen for identifying an advertisement vendor in the exemplary advertising system of FIG. 1;

FIG. 4 is an exemplary display screen for electronically defining the electronically defined geographic advertising area for an advertisement vendor in the exemplary advertising system of FIG. 1;

FIG. 5 is an exemplary map for electronically defining the geographic advertising area for an advertisement vendor in the exemplary advertising system of FIG. 1;

FIG. 6 is an exemplary display screen for electronically associating a banner image for the electronically defined geographic advertising area in the exemplary advertising system of FIG. 1;

FIG. 7 is an exemplary display screen for electronically authorizing an advertisement vendor to sell advertisement messages to advertisers in the exemplary advertising system of FIG. 1;

FIG. 8 is an exemplary display screen for configuring parameters for advertising campaigns in the exemplary advertising system of FIG. 1;

FIG. 9 is an exemplary display screen for configuring categories for advertising campaigns in the exemplary advertising system of FIG. 1;

FIG. 10 is a flow diagram illustrating an exemplary method for identifying an advertiser in the exemplary advertising system of FIG. 1;

FIG. 11 is an exemplary display screen for identifying an advertiser in the exemplary advertising system of FIG. 1;

FIG. 12 is an exemplary map for electronically identifying the location for an advertiser in the exemplary advertising system of FIG. 1;

FIG. 13 is a flow diagram illustrating an exemplary method for electronically identifying a group name for related advertisers in the exemplary advertising system of FIG. 1;

FIG. 14 is an exemplary display screen for electronically identifying a group name for related advertisers in the exemplary advertising system of FIG. 1;

FIG. 15 is a flow diagram illustrating an exemplary method for creating an advertising campaign in the exemplary advertising system of FIG. 1;

FIG. 16 is an exemplary display screen for creating an advertising campaign in the exemplary advertising system of FIG. 1;

FIG. 17 is an exemplary display screen for identifying the preferences for a mobile user for receiving advertisement messages in the exemplary advertising system of FIG. 1;

FIG. 18 is an exemplary display screen for identifying the preferences for a mobile user for receiving advertisement messages, including the distance mode, in the exemplary advertising system of FIG. 1;

FIG. 19 is an exemplary map illustrating the distance between the location of a mobile digital device and the location of an advertiser in the exemplary advertising system of FIG. 1;

FIG. 20 is a flow diagram illustrating an exemplary method for electronically delivering an advertisement message to a mobile digital device in the exemplary advertising system of FIG. 1;

FIG. 21 is an exemplary display screen on a mobile digital device indicating that an advertisement message has been electronically delivered to the mobile digital device in the exemplary advertising system of FIG. 1;

FIG. 22 is an exemplary display screen on a mobile digital device showing the locations of advertisers for whom advertisement messages have been electronically delivered to the mobile digital device in the exemplary advertising system of FIG. 1;

FIG. 23 is an exemplary display screen on a mobile digital device showing the advertisement message electronically delivered to the mobile digital device in the exemplary advertising system of FIG. 1;

FIG. 24 is an exemplary display screen on a mobile digital device showing the websites for an advertiser for whom an advertisement message has been electronically delivered to the mobile digital device in the exemplary advertising system of FIG. 1;

FIG. 25 is an exemplary display screen on a mobile digital device showing the directions to an advertiser for whom an advertisement message has been electronically delivered to the mobile digital device in the exemplary advertising system of FIG. 1;

FIG. 26 is an exemplary display screen on a mobile digital device to share an advertisement message has been electronically delivered to the mobile digital device in the exemplary advertising system of FIG. 1;

FIG. 27 is an exemplary display screen on a mobile digital device showing the group names for adverting campaigns in the exemplary advertising system of FIG. 1; and

FIG. 28 is an exemplary display screen on a mobile digital device showing the advertisement message electronically delivered to the mobile digital device in the exemplary advertising system of FIG. 1.

### DETAILED DESCRIPTION OF THE INVENTION

The inventive method and system relates to reaching customers in a particular manner, specifically at a point when the customer has a mobile digital device that comes within a certain range at which point an advertisement message can be electronically delivered in text and rich video content. The method and system allows for the creating of an advertising campaign, the storage of the pertinent content on a hosted server, and the electronically delivery of the campaign analytics. The usage of the invention can be by an advertisement vendor who has client relationships and who wants to reach consumers directly by companies who want to reach consumers.

The system can reach individuals who have mobile digital devices with targeted electronically delivery of hyper-local advertisement messages. The intention is to create a large platform for electronically delivery of messages that can have text, rich video, and other information with respect to the marketing of items and services. Though the invention can be used directly by the purveyor of services or products, it is also designed to be a tool for advertisement vendors who have advertiser clients desiring to reach customers. For example, a television or radio station might use this method and system to enable an advertiser client to reach the client's customers.

The system enables advertisement vendors, such as broadcast media outlets or other companies providing services to retail or service establishments, to offer to their advertiser clients the ability to reach the customers through targeted hyper-local advertising electronically delivered to mobile digital devices (e.g., SmartPhones, tablets, etc.). It is also a method that can be used directly by retail and service establishments and companies to reach their customers directly with targeted hyper-local advertising. This is accomplished through the creation of a system that has the following characteristics. (1) A server that has the ability to store, electronically deliver, and then produce the analytics of the transactions, (2) application that has video and text of advertisement messages, (3) the connectivity that can send the message to consumer digital devices, and (4) the opportunity and capability of the advertisement vendor or other third party to create the marketing and sales relationship with an advertiser who desires to reach the consumers and their mobile digital devices through targeted hyper-local advertising. The method takes the ability to advertise to a consumer to the next level of connectivity, by making it targeted and hyper-local delivering it within geo-fenced areas. The consumer's mobile digital device is able to detect when it is in the proximity of an advertiser that desires to connect with an advertisement message. The distance within which the mobile digital device is alerted can be adjusted, depending upon the inputs. The communication can be a text message, a video, a QR code, or other representation desired by the advertiser wishing to communicate the informative materials.

The system and method includes a hosted mobile application that electronically delivers the campaign data from the system to the mobile digital device subscriber. The system in turn provides a series of electronic alerts electronically delivered to a customer during the daily commute when on route. The native mobile application sends immediately actionable rich-media advertising information to the customer based on the geo-proximity of the mobile digital device. In one embodiment, the invention is designed to be a hyper-local connection between the advertiser and the customer, that can be facilitated through the sales operations of a media organization (or any other organization) or directly by the advertiser seeking to reach the client. In the instance of a third party media organization or other organization, it is granted a license to use the system for marketing to their base of advertisers.

The activation of the information content of the advertising from the mobile application to the customer is triggered when the customer's mobile digital device is within a certain geographic proximity to the advertiser or within the “sell-zone.” Using a “push” or “pull” delivery notification, together with location based services such as from cell tower and GPS data, the advertising system communicates the advertisement message to the user's mobile digital device where they have opted in to accept the advertisement messages. Once the user accepts the notification, an optional video of, e.g., approximately 5 to 7 seconds can play an advertisement of the offer. Following the video play, the mobile application home screen is displayed and the user will have the option to navigate the advertisement message, or to download, share, or save the coupon deal.

By offering organizations (e.g., media organizations) a method and system to reach advertisers through an intermediary differentiates from other mobile application providers which deal directly between the customer and the advertiser. In doing so, the system brings a unique value to the organizations that augments and leverages their existing advertising platforms. The invention completes the total advertising service an organization can offer by delivering a backend that provides the analytics of usage and furnishes the necessary information for billing to the client. There is also the added advantage of electronically delivering a rich media experience and providing a product that can be fully integrated within the existing advertising platform of the organizations.

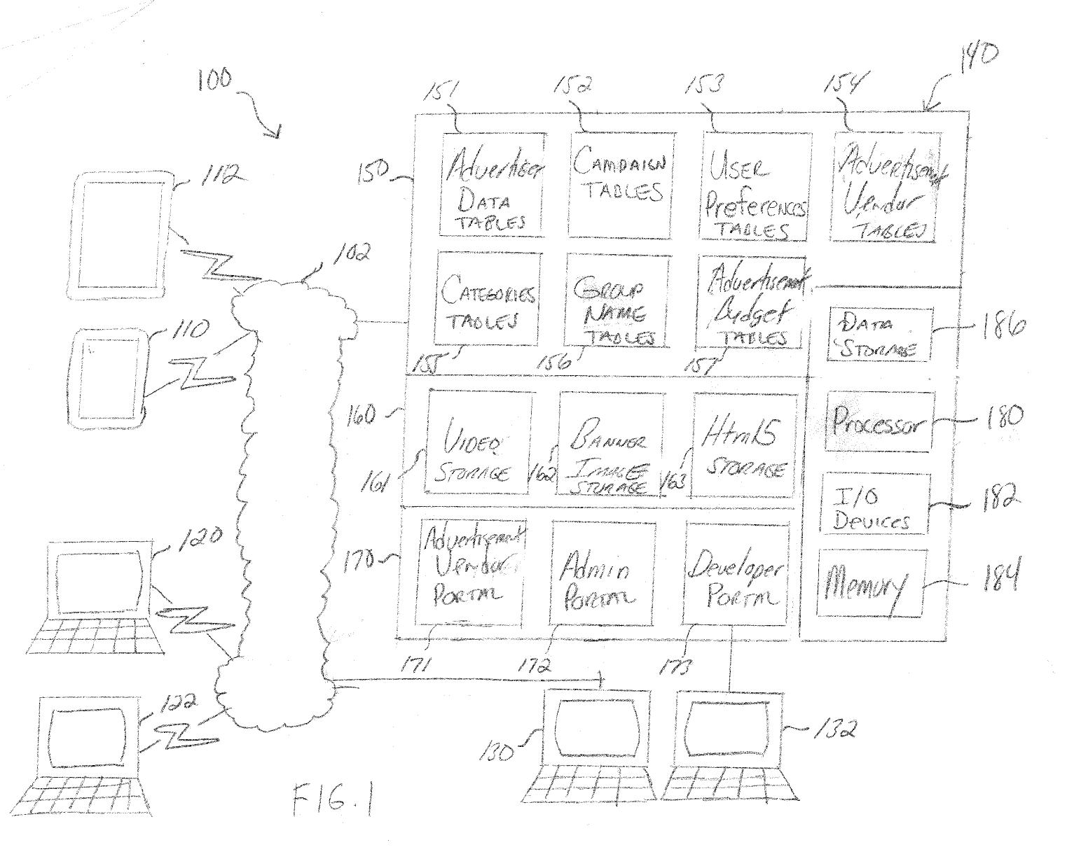

FIG. 1 is a block diagram of an exemplary advertising system 100. In one embodiment, the exemplary advertising system 100 comprises a plurality of mobile digital devices (e.g., a SmartPhone 110, tablet 112, other mobile electronic devices, etc.), a plurality of advertisement vendor workstations (e.g., broadcast media outlet advertisement vendor workstation 120 and retail advertisement vendor workstation 122), an administrator workstation 130, a developer workstation 132, and a server 140 (computing system). The mobile digital devices 110, 112 can be connected to the server 140 over a network 102 (e.g., the Internet, one or more cellular telephone networks, public switched telephone network, cable network, satellite networks, etc.).

In one embodiment, the server 140 includes a portal section 170 including an advertiser portal 171 for connecting to the advertisement vendor workstations 120, 122, an administrator portal 172 for connecting to the administrator workstation 130, and a developer portal 173 for connecting to the developer workstation 132. These workstations 120, 122, 130, 132 can then contact the web-based application and web site of the advertising system. It will be understood that the workstations 120, 122, 130, 132 can be connected over the network 102 or directly to the server 140. The server 140 also includes a processor 180 (e.g., central processor unit (CPU), etc.), various input/output (I/O) devices 182, memory 184 (e.g., RAM, ROM, hard disk drives, etc.), and data storage device 186. The data storage device 186 can store a program include instructions for the processor 180 to execute the methods described in the inventive advertising system 100 and that stores data accumulated or computed by the processor 180 on the data storage device 186. The server 140 includes a media storage section 160, including video storage device 161, banner image storage device 162, and Html5 storage device 163, for storing content associated with advertisement vendors, advertisers, and advertisement messages. The server 140 also includes a database storage section 150, including advertiser data tables 151, campaign tables 152, user preference tables 153, advertisement vendor tables 154, categories tables 155, group name tables 156, and advertisement budget tables 157. The server 140 can be implemented as one or more personal computers or workstations or as a Web server within an Internet environment hosting a “portal” Web site. The advertising system 100 will provide analytics to both the administrator and the advertisement vendor, including the number of advertisement messages sent, viewed, and unviewed for a particular advertising campaign, advertiser, geographic advertising area, etc.

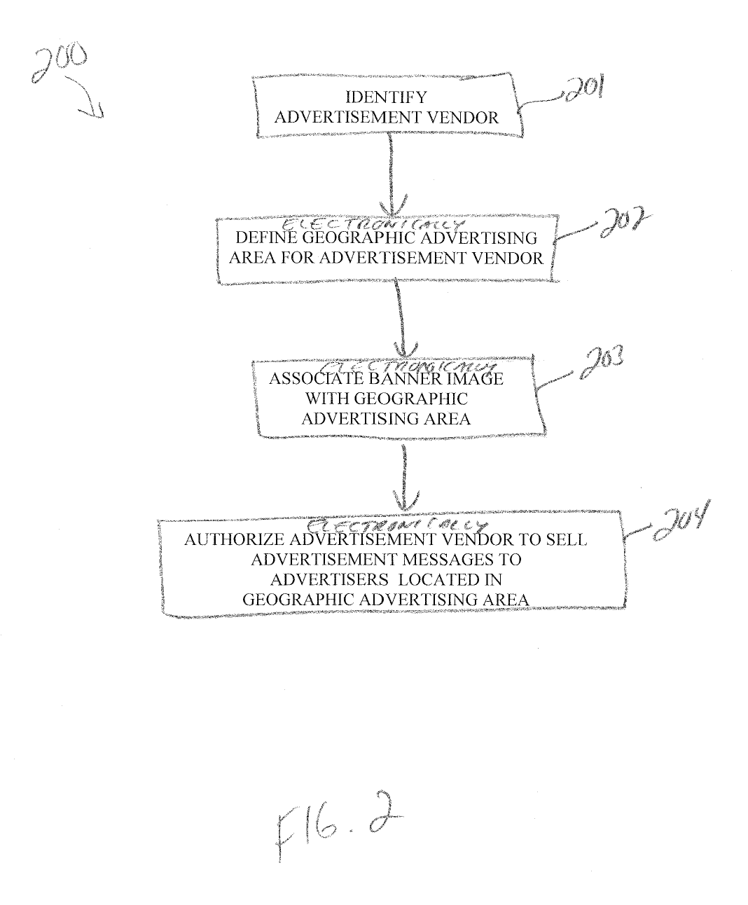

FIG. 2 is a flow diagram illustrating an exemplary method 200 for identifying an advertisement vendor in the exemplary advertising system 100 of FIG. 1. In one embodiment, the method 200 can be performed by an advertising system administrator using the administrator work station 130.

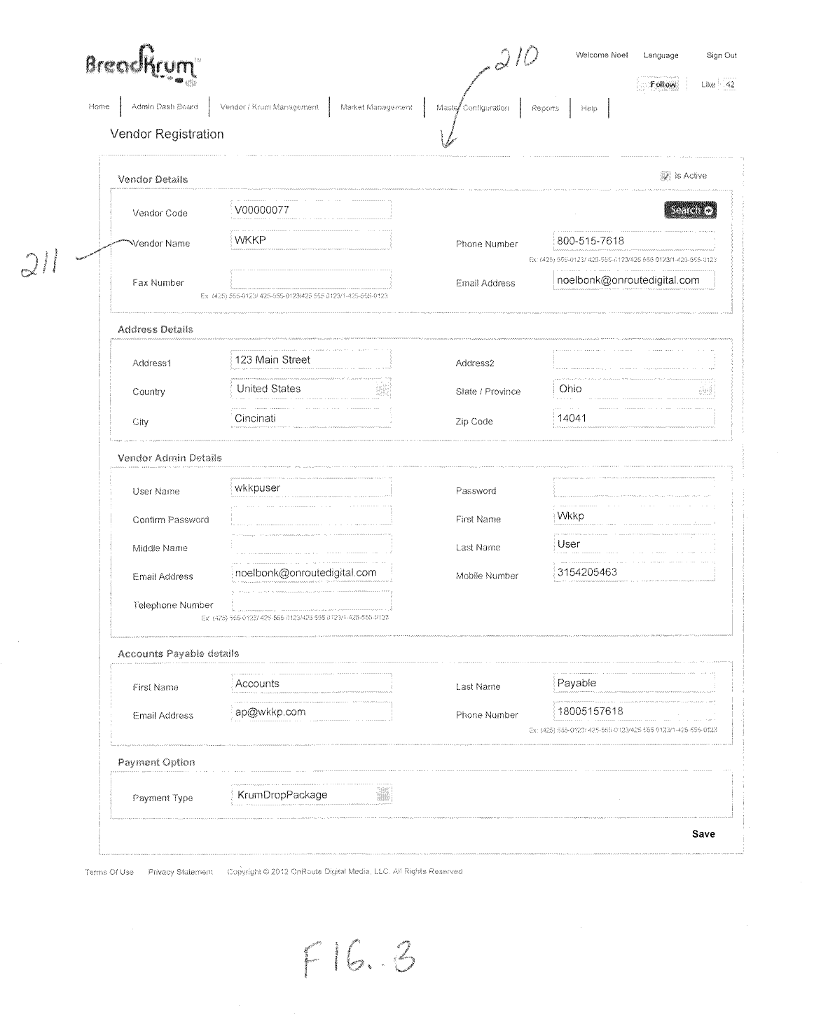

At step 201, the administrator identifies the advertisement vendor. FIG. 3 is an exemplary display screen 210 for identifying an advertisement vendor, including the name 211 of the advertisement vendor (e.g., station WKKP). Each advertisement vendor (e.g., different broadcast media outlets) will be provided a unique advertisement vendor name 211 that can be stored in the advertisement vendor tables 154 (FIG. 1).

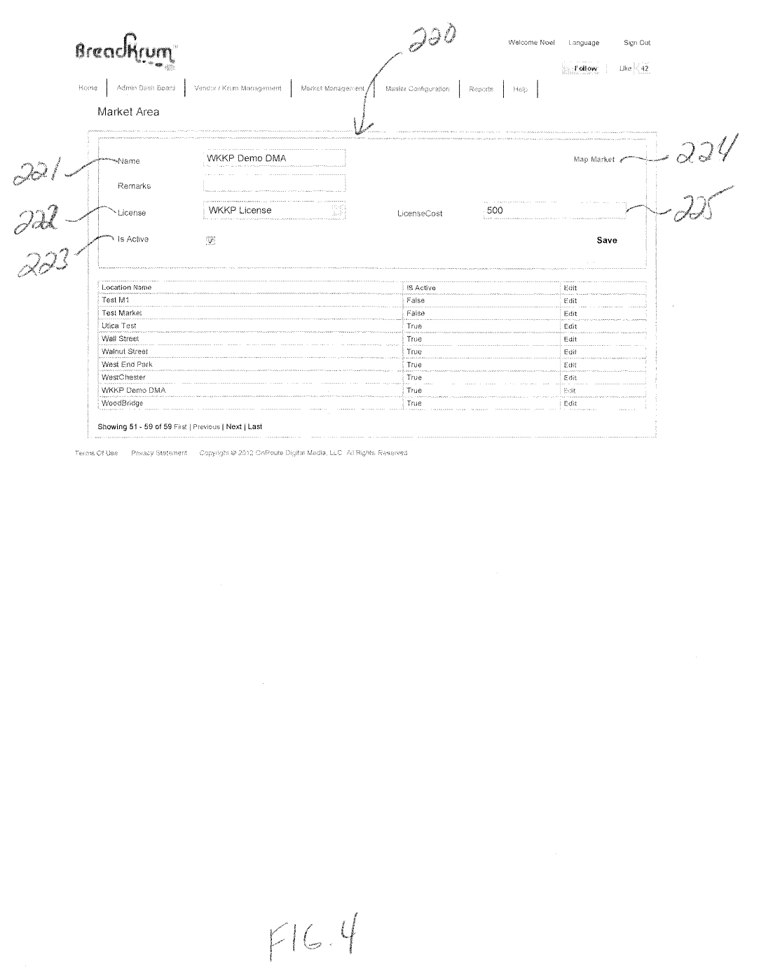

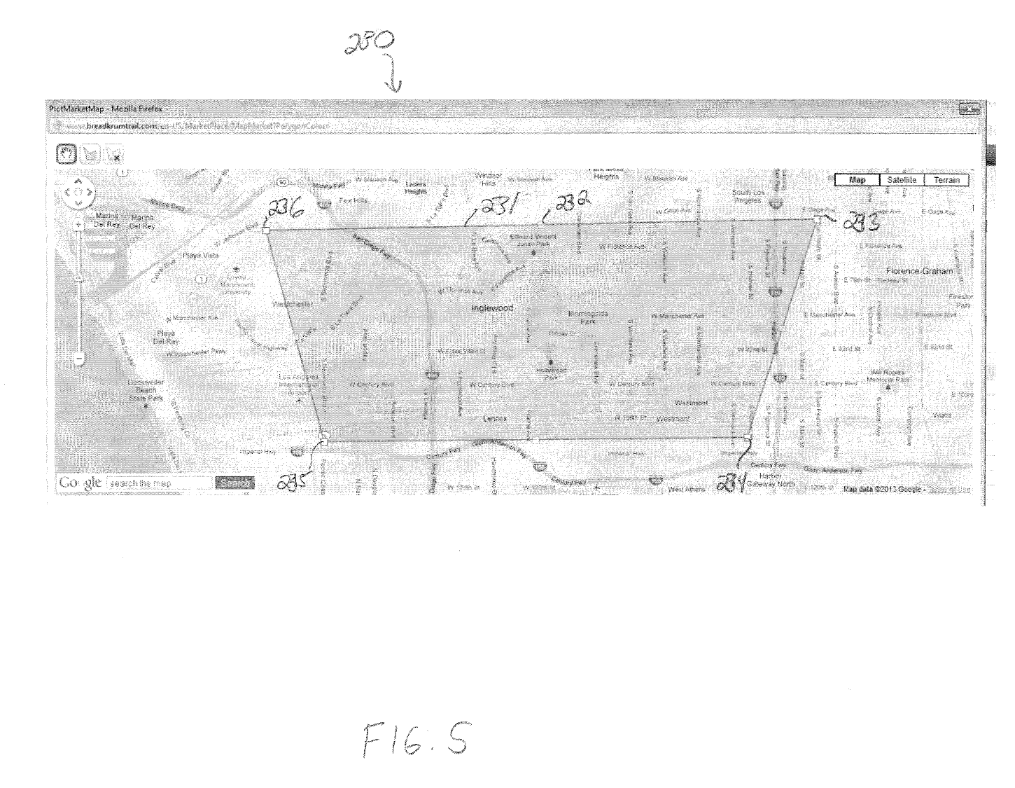

At step 202, the administrator electronically defines the geographic advertising area 231 (shown as “Market Area” in Figures) for the advertisement vendor. FIG. 4 is an exemplary display screen 220 for electronically defining the geographic advertising area 231 for an advertisement vendor, including the name 221 of the geographic advertising area 231 (e.g., WKKP Demo DMA). FIG. 5 is an exemplary map 230 for electronically defining the geographic advertising area 231. In one embodiment, the administrator can select the map icon 224 on the display screen 220 to use an Application Programming Interface (API) for a map software program (e.g., Google Maps) to draw a virtual fence around the geographic advertising area 231 by forming a polygon between several selected points 232, 233, 234, 235, 236 on the map 230. The geographic advertising area 231 can also be defined by entering the coordinates of the points of the polygon into the advertising system 100. The electronically defined geographic advertising area 231 for an advertisement vendor can be stored in the advertisement vendor tables 154 (FIG. 1). For example, the coordinates (latitude and longitude) of the vertices of the polygon forming the electronically defined geographic advertising area 231 can be stored.

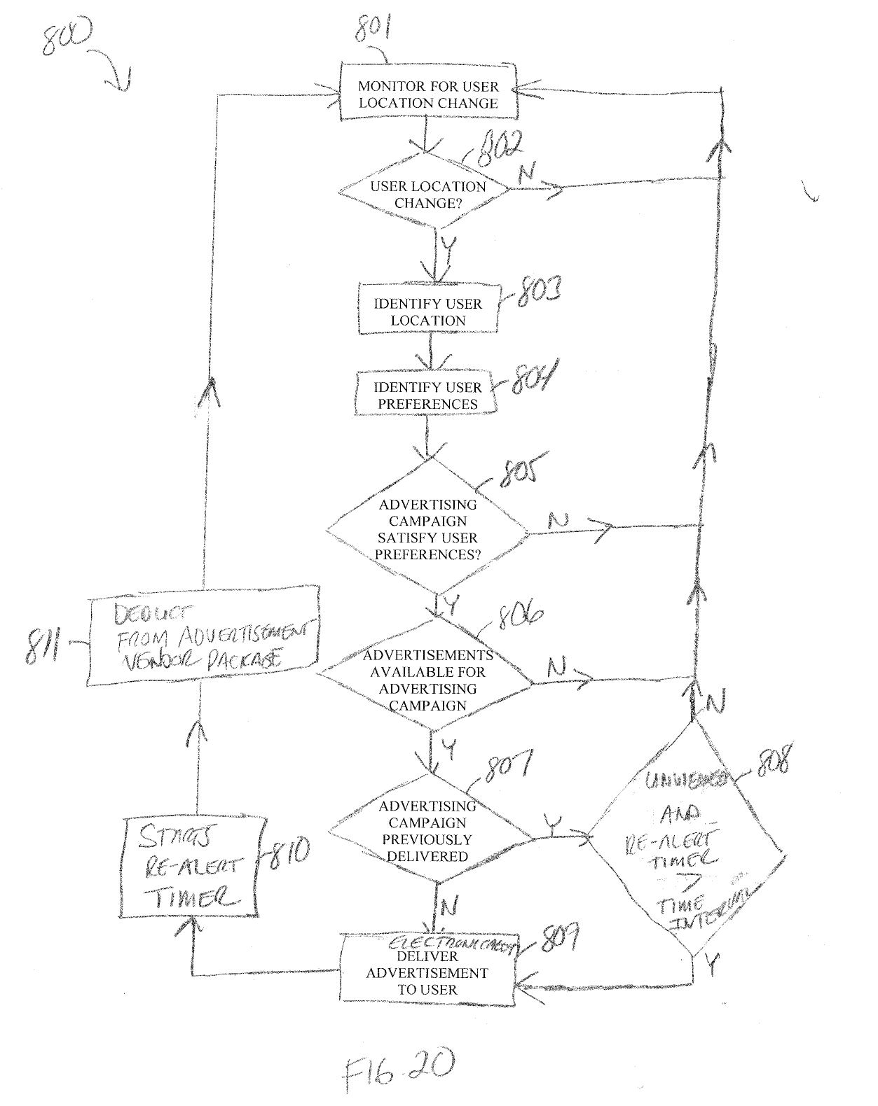

At step 203, the administrator electronically associates (e.g., uploads) a banner image 834 (FIG. 6) (or other identifier) with the electronically defined geographic advertising area 231 that will be displayed on a mobile digital device 110 as shown in FIG. 22. FIG. 6 is an exemplary display screen 240 for electronically associating a banner image 834 for an electronically defined geographic advertising area 231. For a particular geographic advertising area name 241, the administrator can electronically associate a uniform resource locator (URL) (web address) 242 as well as a banner image 243 that will be displayed on a SmartPhone and a banner image 244 that will be displayed on a tablet. The banner image 834 can be stored in the banner image storage device 162 (FIG. 1). As shown in FIG. 4, the administrator can also provide the name 222 of the license that will be provided as well as the license cost 225 and set whether the electronically defined geographic advertising area 231 is active 223.

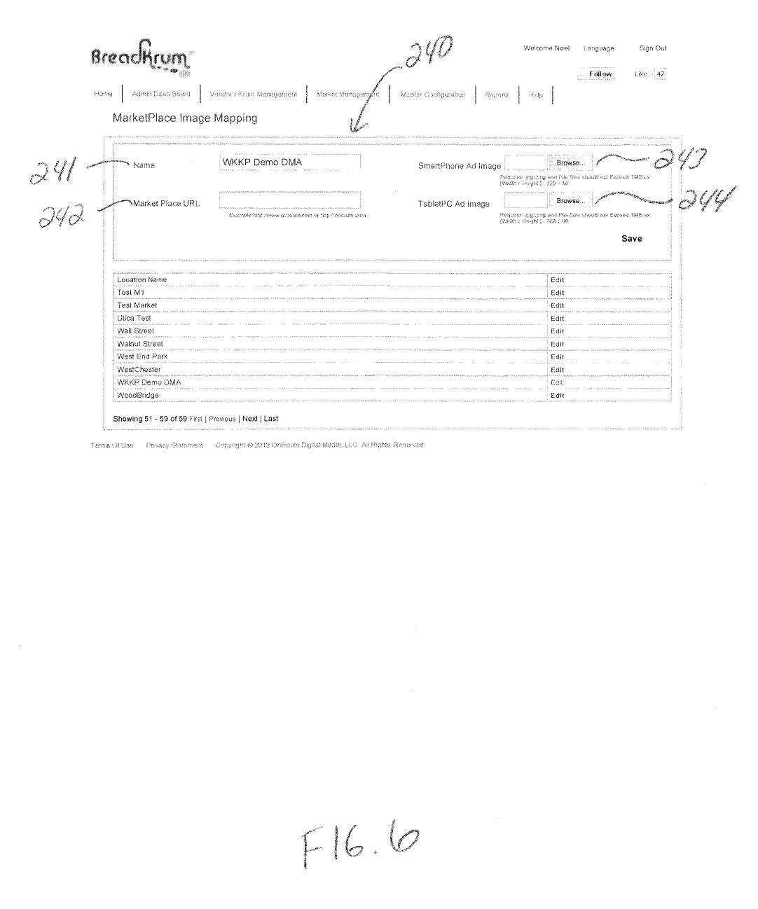

At step 204, the administrator authorizes the advertisement vendor to sell advertisement messages to advertisers located in the electronically defined geographic advertising area 231. FIG. 7 is an exemplary display screen 250 for electronically authorizing an advertisement vendor to sell advertisement messages to advertisers. In one embodiment, the administrator can provide a name 251 and description 252 for the package of advertisements and set whether the package of advertisements is active 255. In some arrangements, the advertisement vendor will be allowed to pay-as-they go with no predetermined maximum number of advertisement messages (shown as “Krums” in the figures). In FIG. 7, the administrator can set the maximum advertisement message count 253 (or budget) and the cost 254 for that package of advertisement messages. The advertisement package can be stored in the advertisement budget tables 157 (FIG. 1). The advertisement vendor is then authorized to sell that number of advertisement messages to its advertisers in the electronically defined geographic advertising area 231.

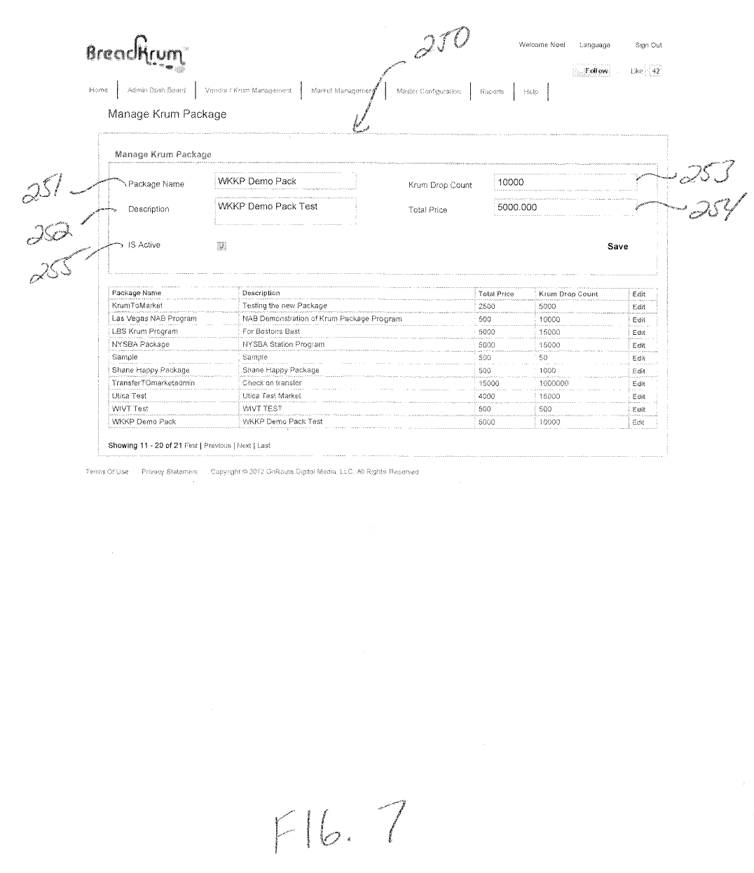

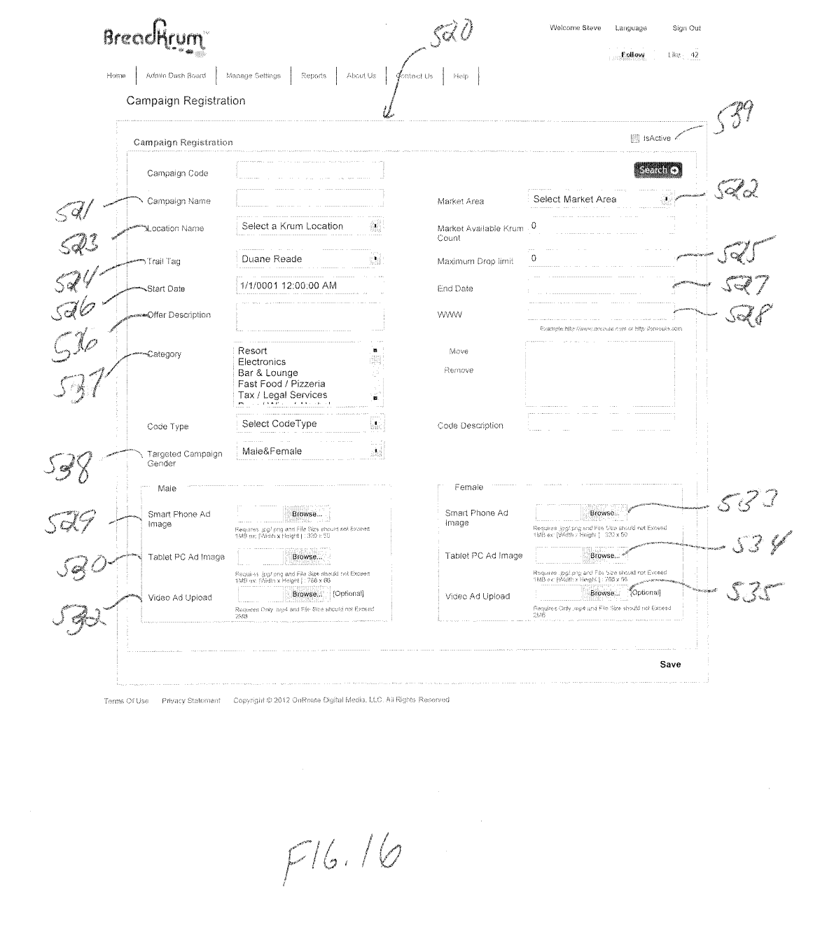

FIG. 8 is an exemplary display screen 260 for configuring parameters for advertising campaigns in the exemplary advertising system 100 of FIG. 1. In one embodiment, the administrator can configure the distance (e.g., in miles) within which a mobile digital device 110 should receive an advertisement message when in proximity to an advertiser 321 as shown in FIG. 19. For example, the administrator can configure the distance for walk (short) mode 261, mid-range (vehicle) mode 262, and long range (custom) mode 263. In addition, the administrator can set the number of advertisement messages that should be deducted from an advertisement vendor's package when an advertisement message is electronically delivered 264 or when an advertisement message with video content is electronically delivered 265. The administrator can also specify the re-alert time interval (e.g., in hours) 266 that determines how long after an advertisement message has been electronically delivered to a mobile digital device 110 can the advertisement message be sent again if the original advertisement message was not viewed and the conditions are such (e.g., mobile digital device 110 has entered the electronically defined geographic advertising area again) that the advertisement message will be sent again.

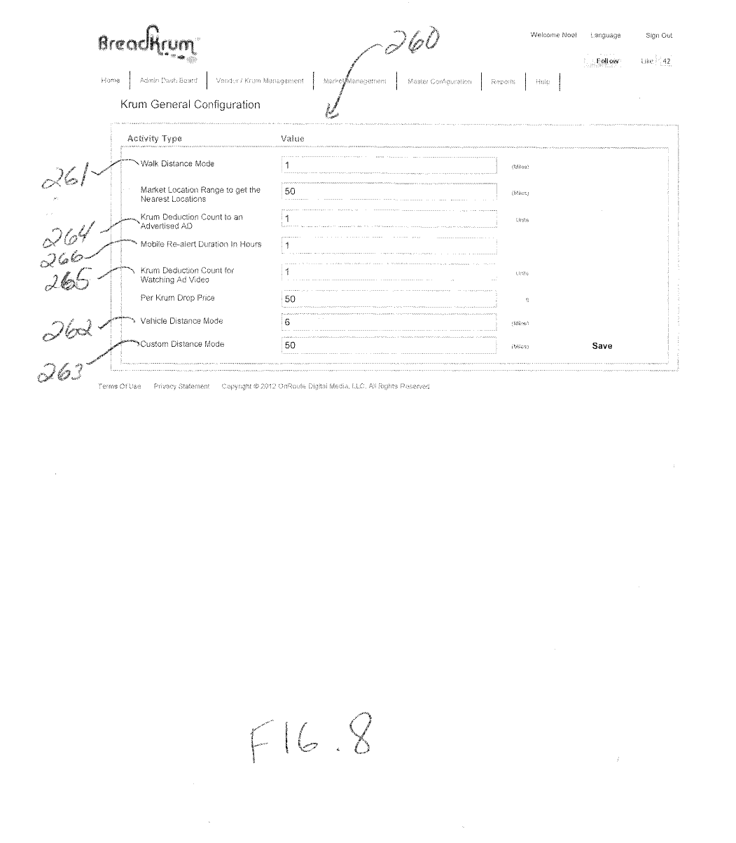

FIG. 9 is an exemplary display screen 270 for configuring categories for advertising campaigns in the exemplary advertising system 100 of FIG. 1. The administrator can provide a name 271 and description 272 for a variety of different categories (e.g., automotive, electronics, fast food/pizzeria, etc.) that can then be electronically associated with advertising campaigns. The categories can be stored in the categories tables 155 (FIG. 1). The administrator can set whether the category is active 273.

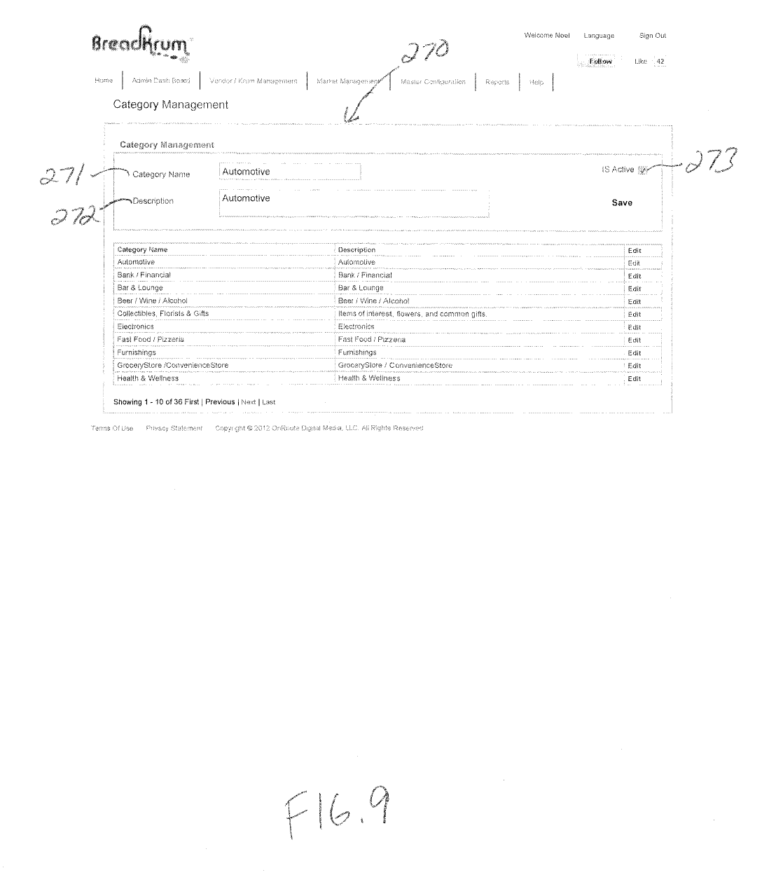

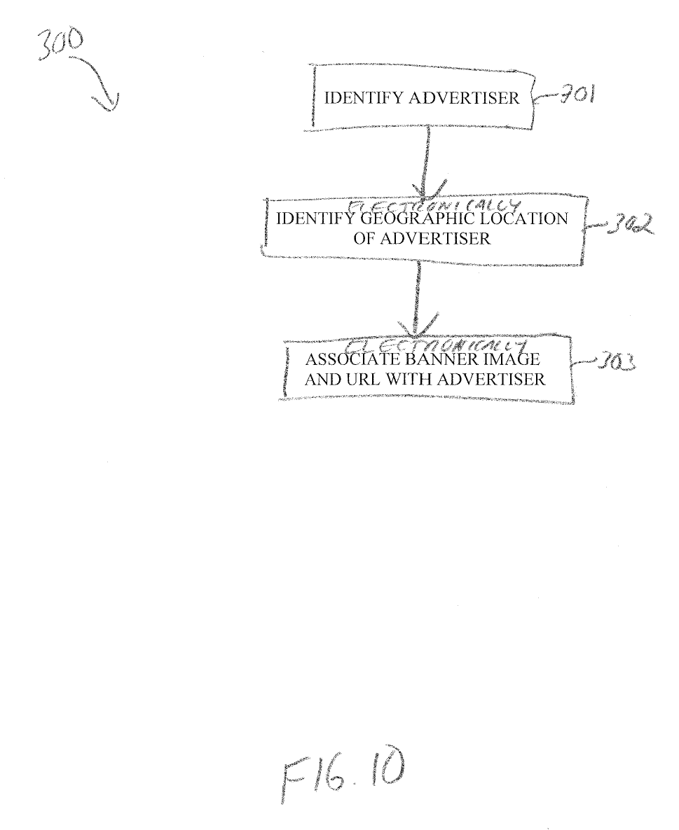

FIG. 10 is a flow diagram illustrating an exemplary method 300 for identifying an advertiser in the exemplary advertising system 100 of FIG. 1. An advertiser can be any entity (company, enterprise, individual, charitable organization, school, etc.) that it is interested in distributing advertisement messages to mobile digital device users about an offer or event (or other information). At step 301, the advertisement vendor identifies the advertiser (shown as “Location Name” in the Figures). FIG. 11 is an exemplary display screen 310 for identifying an advertiser, including the name 312 of the advertiser. As shown in FIG. 11, the geographic advertising area 311 for the advertiser should be specified. Each advertiser will be provided a unique advertiser name 312 that can be stored in the advertiser data tables 151 (FIG. 1).

At step 302, the advertisement vendor electronically identifies the geographic location 321 of the advertiser. FIG. 12 is an exemplary map 320 for identifying the location 321 for an advertiser in the geographic advertising area 231. The advertisement vendor can select the map icon 313 on the display screen 310 to use an Application Programming Interface (API) for a map software program (e.g., Google Maps) to select the location 321 of the advertiser on the map 320. In addition, as shown in FIG. 11, the location can also be provided by entering the address 314 of the advertiser into the advertising system. The electronically identified location 321 of the advertiser can be the coordinates (latitude and longitude) of the vertices of the location and can be stored in the advertiser data tables 151 (FIG. 1).

At step 303, the advertisement vendor electronically associates a banner image (or other identifier) and URL with the advertiser. As shown on FIG. 11, advertisement vendor can electronically associate a uniform resource locator (URL) (web address) 317 as well as a banner image 315 that will be displayed on a SmartPhone and a banner image 316 that will be displayed on a tablet. The banner images can be stored in the banner image storage device 162 (FIG. 1). As shown in FIG. 11, the advertisement vendor can also set whether the advertiser is active 318.

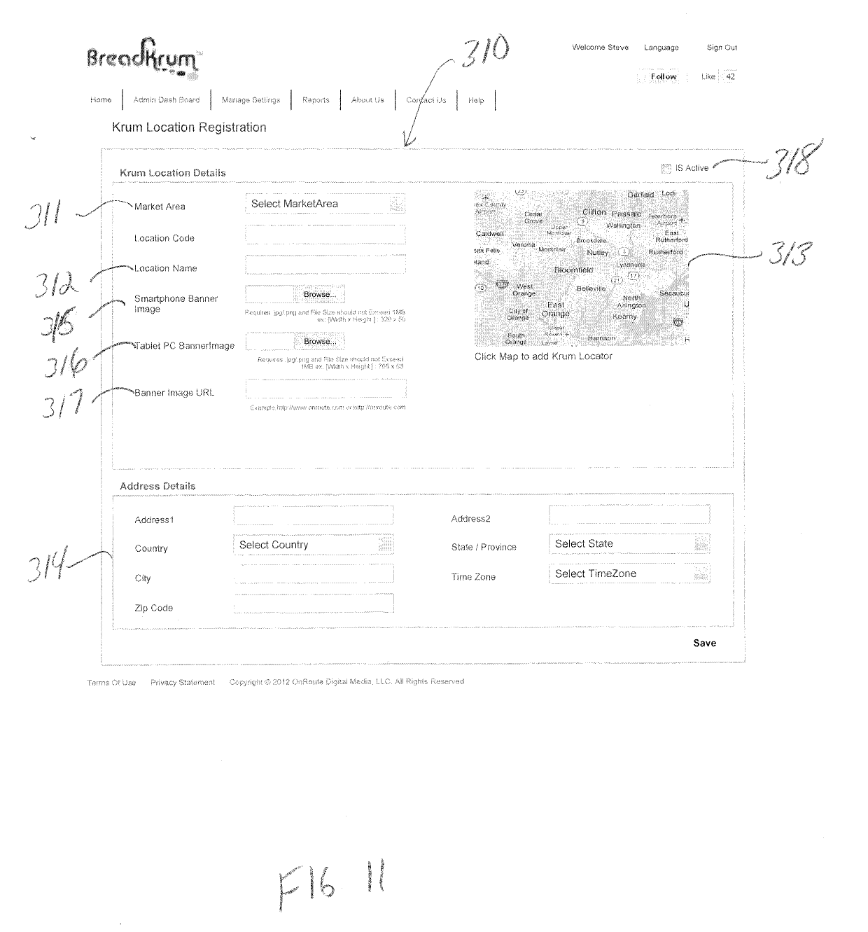

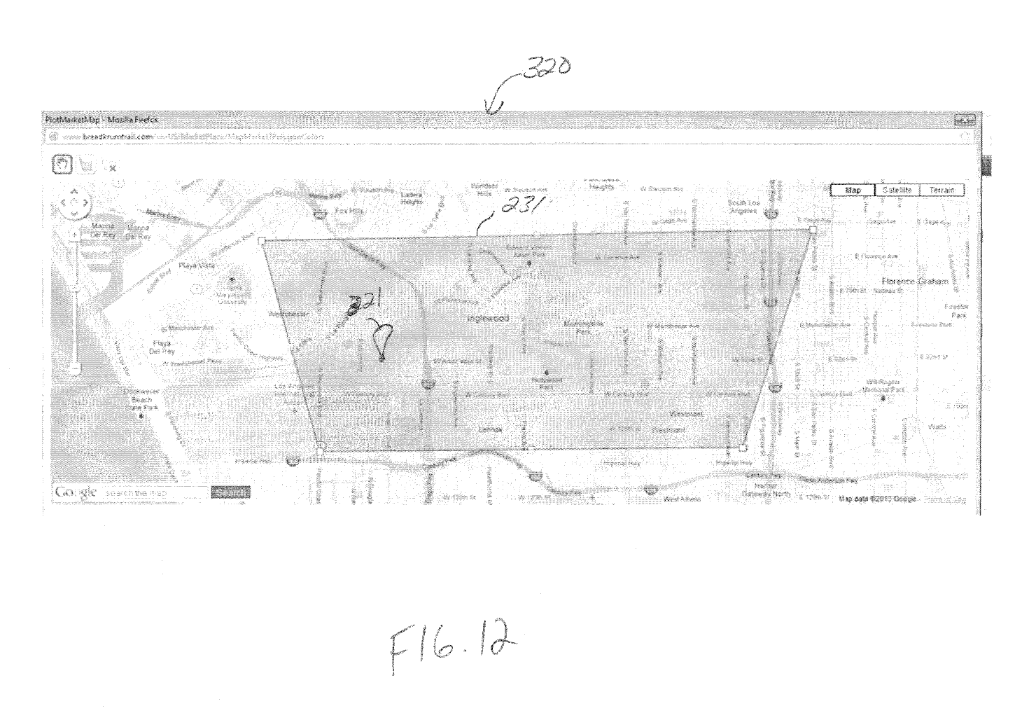

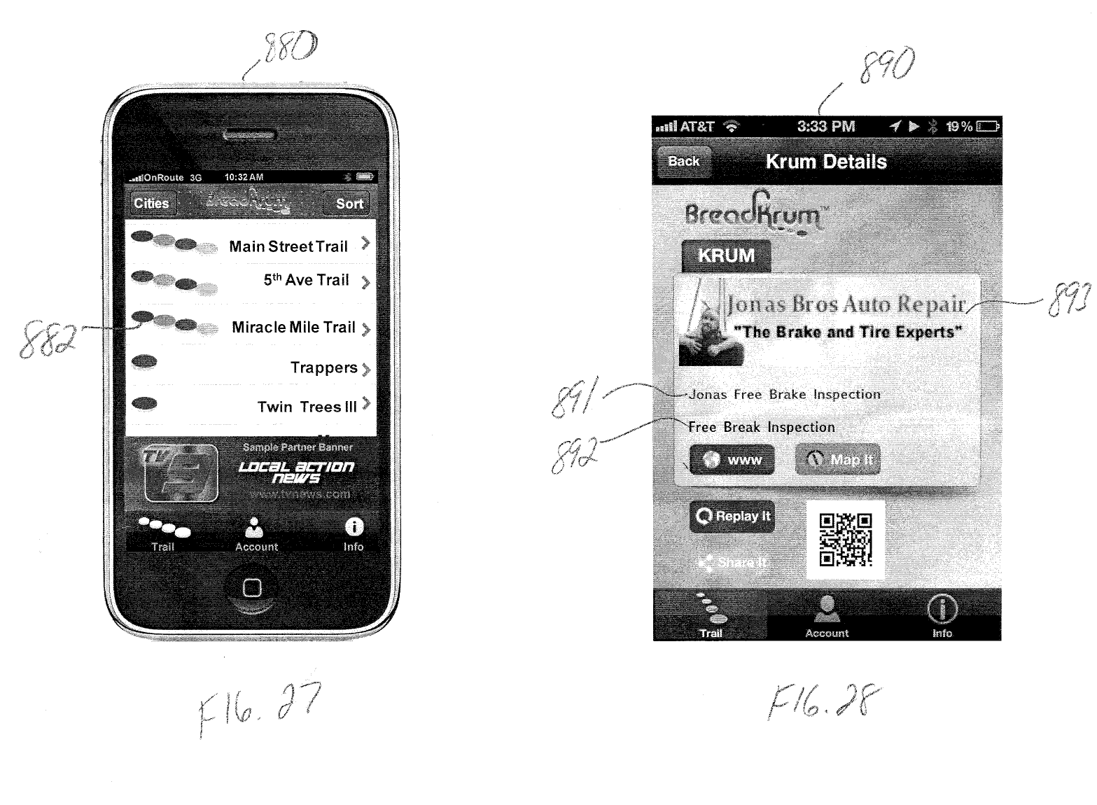

FIG. 13 is a flow diagram illustrating an exemplary method 400 for electronically identifying a group name 882 (FIG. 27) for related advertisers in the exemplary advertising system 100 of FIG. 1. At step 401, the advertisement vendor can electronically identify a group name 411 (referred to as “Trail Tag”) for related advertisers. FIG. 14 is an exemplary display screen 410 for identifying a group name 411 for related advertisers. A group name 411 can be assigned to a group of advertisers that have something in common (geographic proximity, similar restaurants, part of same commercial chain, etc.). As shown in FIG. 27, the group name 882 is shown on a display 880 on a mobile digital device. At step 402 and as shown in FIG. 14, the advertisement vendor can also provide a description 412 for the group name 411 and set whether the group name is active 413. As will be explained, advertisement campaigns can be electronically associated with these group names and a mobile user can use the group names to see all of the advertisements available for a particular group. The group name 411 can be stored in the group name tables 156 (FIG. 1). At step 403, the advertisement vendor can electronically associate a banner image and URL with the group name.

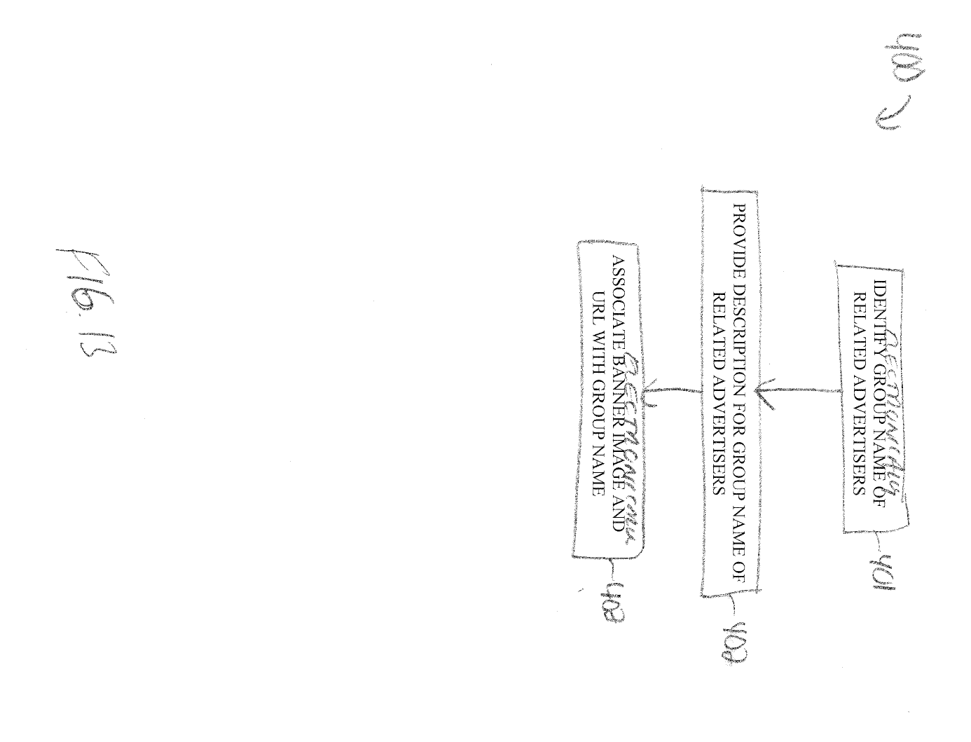

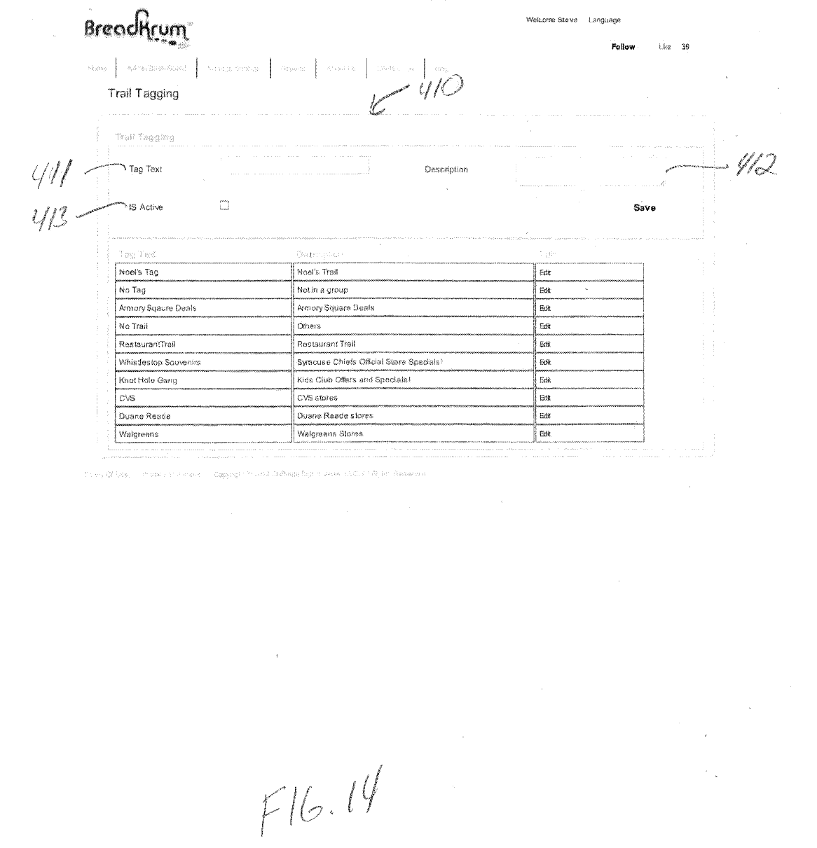

FIG. 15 is a flow diagram illustrating an exemplary method 500 for creating an advertising campaign in the exemplary advertising system 100 of FIG. 1. FIG. 16 is an exemplary display screen 520 for creating an advertising campaign. At step 501, the advertisement vendor identifies the advertising campaign by providing a campaign name 521 (labeled 891 in the advertisement message shown FIG. 28). At step 502, the advertisement vendor electronically associates the electronically defined geographic advertising area 522 with the advertising campaign. At step 503, the advertisement vendor electronically associates the advertiser name 523 with the advertising campaign. The advertiser must be located in the electronically defined geographic advertising area 522. At step 504, the advertisement vendor electronically associates the group name 524 with the advertising campaign. At step 505, the advertisement vendor identifies the maximum number of advertisement messages 525 for the advertising campaign. At step 506, the advertisement vendor identifies the description 536 for the advertising campaign (labeled 892 in the advertisement message shown FIG. 28). At step 507, the advertisement vendor identifies the start date/time 526 and the end date/time 527 for the advertising campaign. The advertisement vendor can set whether the advertising campaign is gender neutral or not 528.

At step 508, the advertisement vendor electronically associates the advertisement message with the advertising campaign. As shown in FIG. 16, the advertisement message for a male can include a banner image 529 that will be displayed on a SmartPhone (labeled 893 in the advertisement message shown FIG. 28), a banner image 530 that will be displayed on a tablet, and a video pre-roll 532. The advertisement message for a female can include a banner image 533 that will be displayed on a SmartPhone, a banner image 534 that will be displayed on a tablet, and a video pre-roll 535. The banner images 529, 530, 533, 534 can be stored in the banner image storage device 162 (FIG. 1). The video 532, 535 can be stored in the video storage device 161 (FIG. 1). The advertising campaign can be stored in the campaign tables 152 (FIG. 1).

In addition and as shown in FIG. 16, the advertisement vendor can identify the category 537 for the advertising campaign and set whether the campaign is active 539. The advertisement vendor can electronically associate a uniform resource locator (URL) (web address) 528 for the advertising campaign.

The advertising system 100 includes a mobile application installed on the mobile digital devices 110, 112. The mobile application can be a native mobile application or in a Software Development Kit (SDK) that enables a programmer to integrate the mobile application into an advertisement vendor's existing mobile application. The mobile application is designed to be the gateway for multiple advertising campaigns. Combining personalized, immediately actionable rich-media advertising information and “always on” proximity based push notifications, the mobile application provides relevant notification alerts to the subscribed user. Push notifications received on the mobile digital device are based on proximity to the advertiser as well as selected user preferences that the user can selectively configure within the mobile interface. The mobile interface provides the mechanism for the user to subscribe and opt into the service.

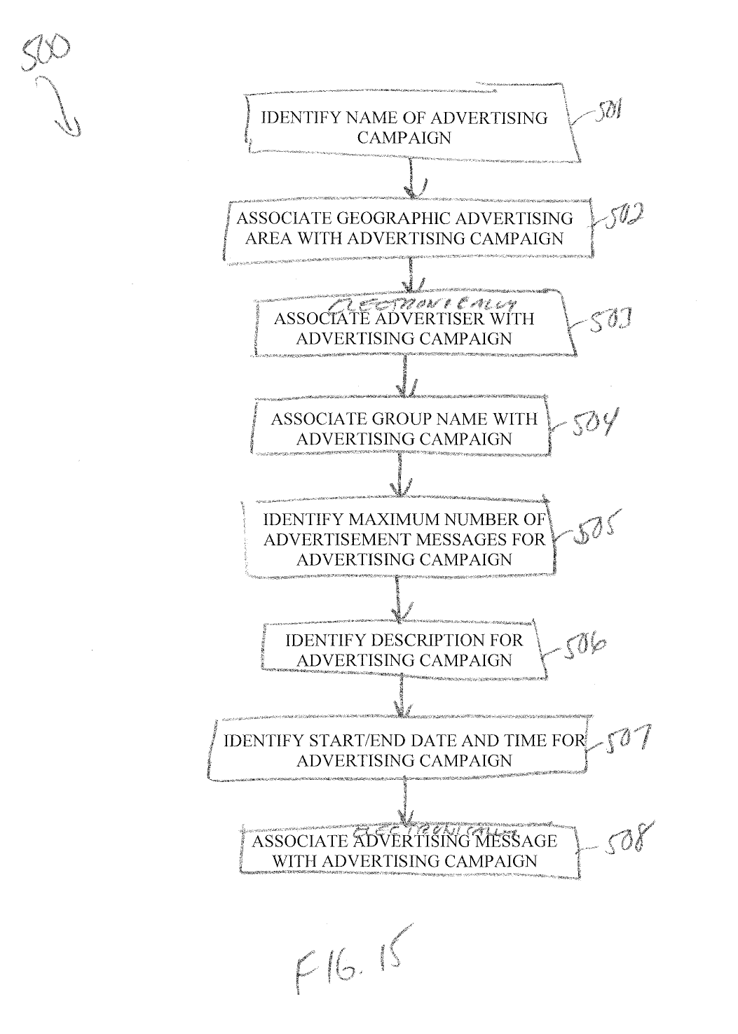

FIG. 17 is an exemplary display screen 700 for identifying the preferences for a mobile user for receiving advertisement messages in the exemplary advertising system 100 of FIG. 1. The user can set alert categories 701 to identify the categories (FIG. 9) for which the user wishes to receive advertisement messages. The user can set the language preference 702 (e.g., English, Spanish, French) for the mobile application. The user can provide its information relating to any social networks 703 that the user is a member of. The user can also provide its registration information 704, including identification (gender, age) and address information. FIG. 18 is an exemplary display screen 710 for identifying the preferences for a mobile user for receiving advertisement messages, including the distance mode 711, in the exemplary advertising system 100 of FIG. 1. In one embodiment, the user can configure the distance (e.g., in miles) 722 within which a mobile digital device 721 should receive an advertisement message when in proximity to an advertiser 321 as shown in on the map 720 of FIG. 19. For example, the administrator can configure the distance for walk (short) mode, mid-range (vehicle) mode, and long range (custom) mode. In addition. The user preferences can be stored in the user preferences tables 153 (FIG. 1).

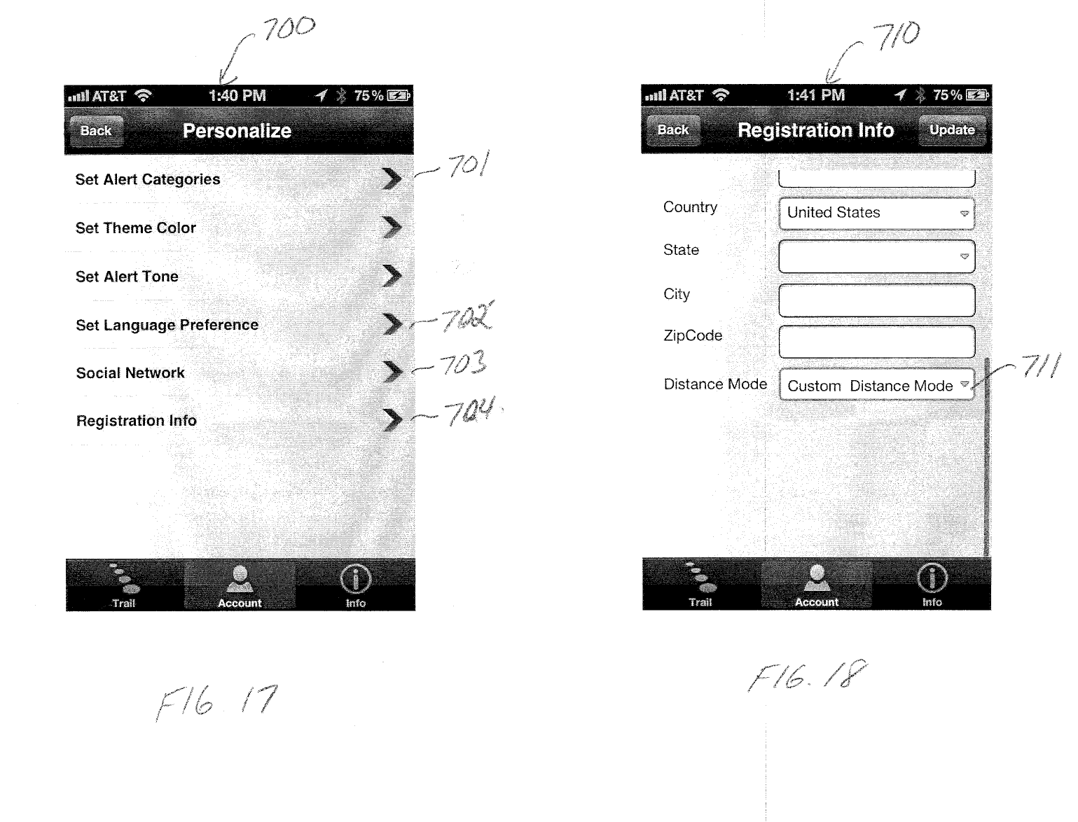

FIG. 20 is a flow diagram 800 illustrating an exemplary method for electronically delivering an advertisement message to a mobile digital device in the exemplary advertising system 100 of FIG. 1. At step 801, the advertising system 100 monitors the user's mobile digital device 110 for a location change. For example, the mobile application on the mobile digital device 110 can determine whether a major location change has occurred by a combination of GPS satellite, Wi-Fi, Cell tower triangulation, and monitoring location services and GPS of the mobile digital device 110. A major location change event could occur when the mobile digital device switches from one cell tower to another or if the distance between last known location and current location is greater than a specified value. At step 802, the advertising system 100 determines whether there has been a user location change. If there has been no user location change, the advertising system 100 returns to monitor at step 801. If there has been a user location change, the mobile digital device calls the server 140 over an available data connected network 102.

In addition, if the user selects and opens the mobile application on the mobile digital device, the mobile digital device calls the server 140 over an available data connected network 102 before proceeding to step 803.

At step 803, the advertising system 100 electronically identifies the location of the mobile digital device (e.g., latitude and longitude). At step 804, the advertising system 100 electronically identifies the user preferences (age, gender, categories, distance, etc.) from the user preferences table 153 (FIG. 1). At step 805, the advertising system 805 determines if any available advertising campaign is available based on the user's location and preferences. For example, if the user's location is outside of any geographic advertising area or if there are no advertising campaigns that match any of the user's preferred categories, then the advertising system 100 returns to monitor at step 801.

If there is an advertisement campaign that satisfies the user's preferences, at step 806, the advertising system 100 determines if there are any more advertisement messages available for that advertising campaign. If there are no more advertisement messages available, then the advertising system 100 returns to monitor at step 801. If there are more advertisement messages available, at step 807, the advertising system 100 determines if the advertisement message from that advertisement campaign has previously been electronically delivered to the user. If not, the advertisement message is electronically delivered to the user's mobile digital device at step 809. If the advertisement message from that advertisement campaign has previously been electronically delivered to the user, at step 808, the advertising system 100 determines if the advertisement message remains unviewed and if the re-alert timer that started when the original advertisement message was electronically delivered is greater than the time interval 266 set in FIG. 8. If the answer is no to either question, then the advertising system 100 returns to monitor at step 801. If the answer is yes to both questions, the advertisement message is electronically delivered to the user's mobile digital device at step 809. After the advertisement message is electronically delivered, the advertising system 100 starts the re-alert timer for that advertising campaign at step 810 and deducts an advertisement from the total number of advertisement messages remaining from the package for that advertising campaign at step 811 before the advertising system 100 returns to monitor at step 801.

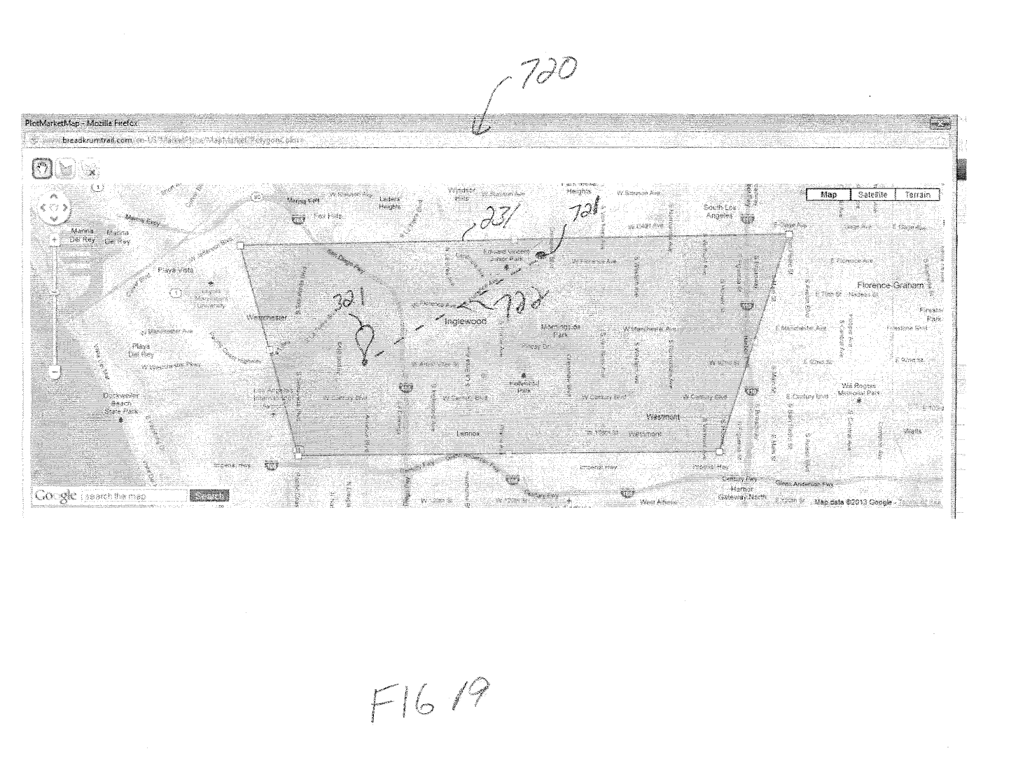

FIG. 21 is an exemplary display screen 820 on a mobile digital device indicating that an advertisement message has been electronically delivered to the mobile digital device in the exemplary advertising system 100 of FIG. 1. The icon 821 for the mobile application includes a number (7) that indicates the number of advertisement messages electronically delivered to the mobile digital device. In addition, the alert 822 includes a view button 823 that when pressed allows the location of the advertisers to be seen as shown in FIG. 22.

FIG. 22 is an exemplary display screen 830 on a mobile digital device showing the locations of advertisers for whom advertisement messages have been electronically delivered to the mobile digital device in the exemplary advertising system 100 of FIG. 1. Located at the bottom of the display is the banner image 834 of the electronically defined geographic advertising area. The received advertisement messages include the most recently received message 832, unviewed advertisement messages 833 (colored red), and viewed messages 831 (colored blue).

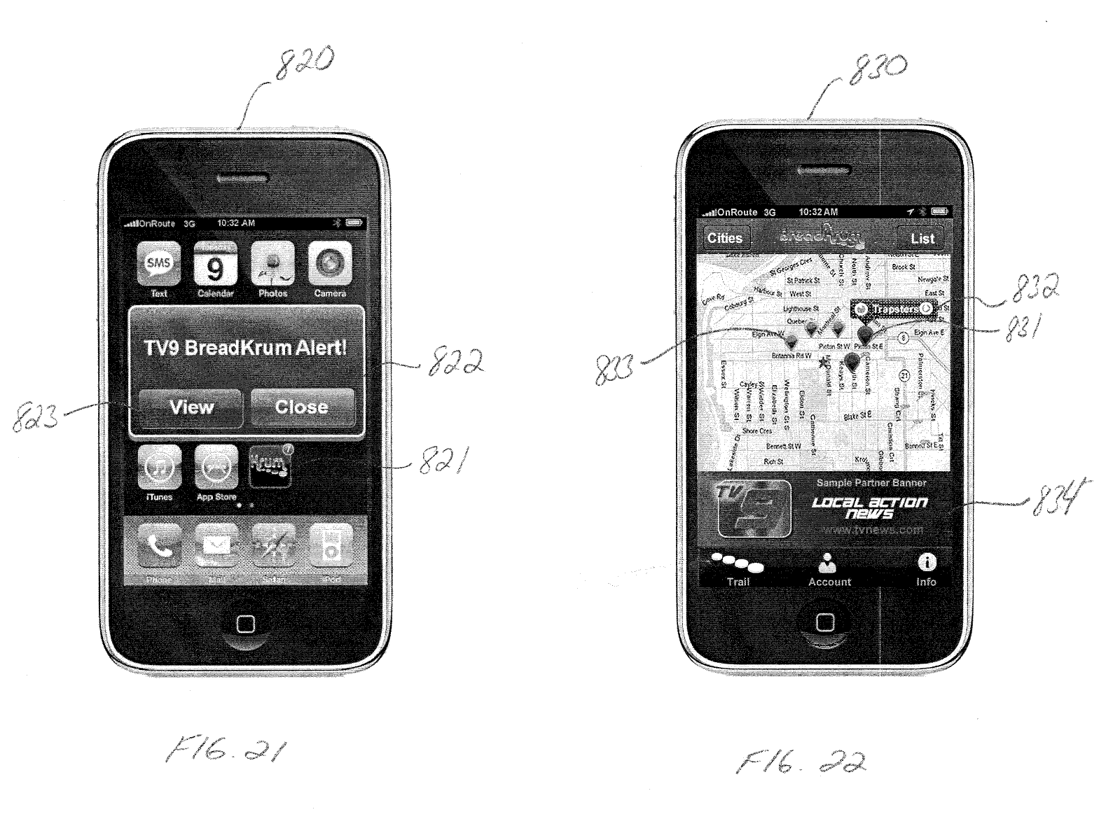

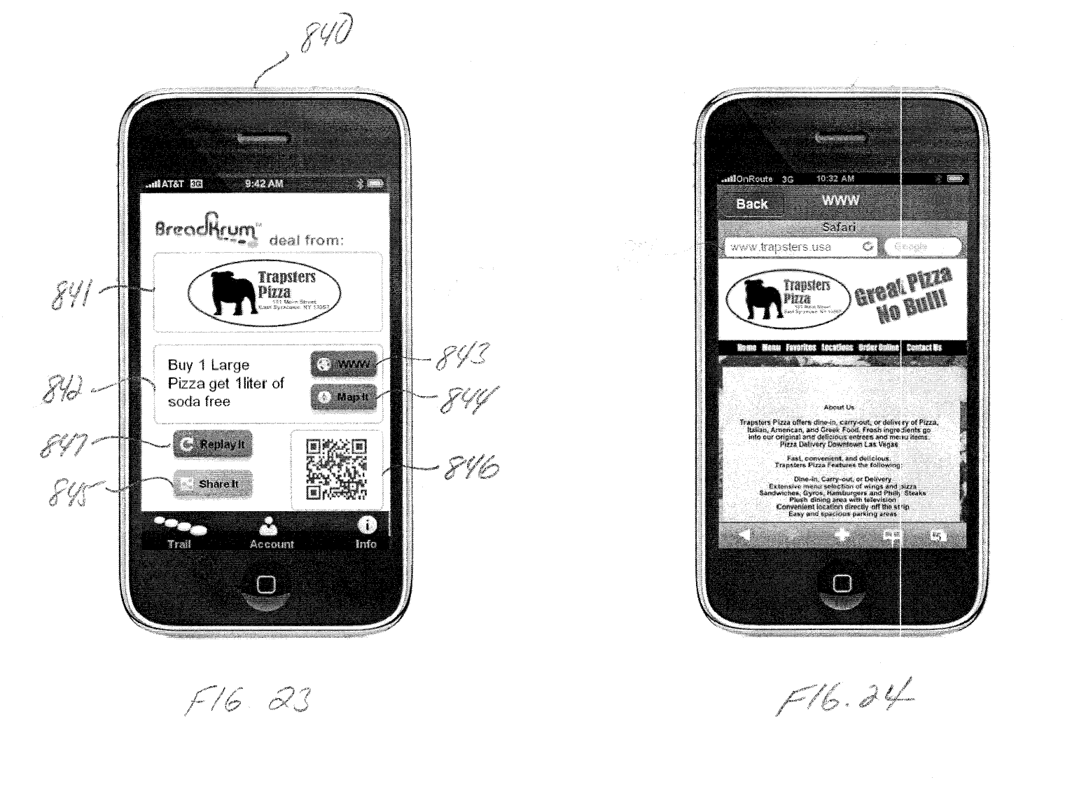

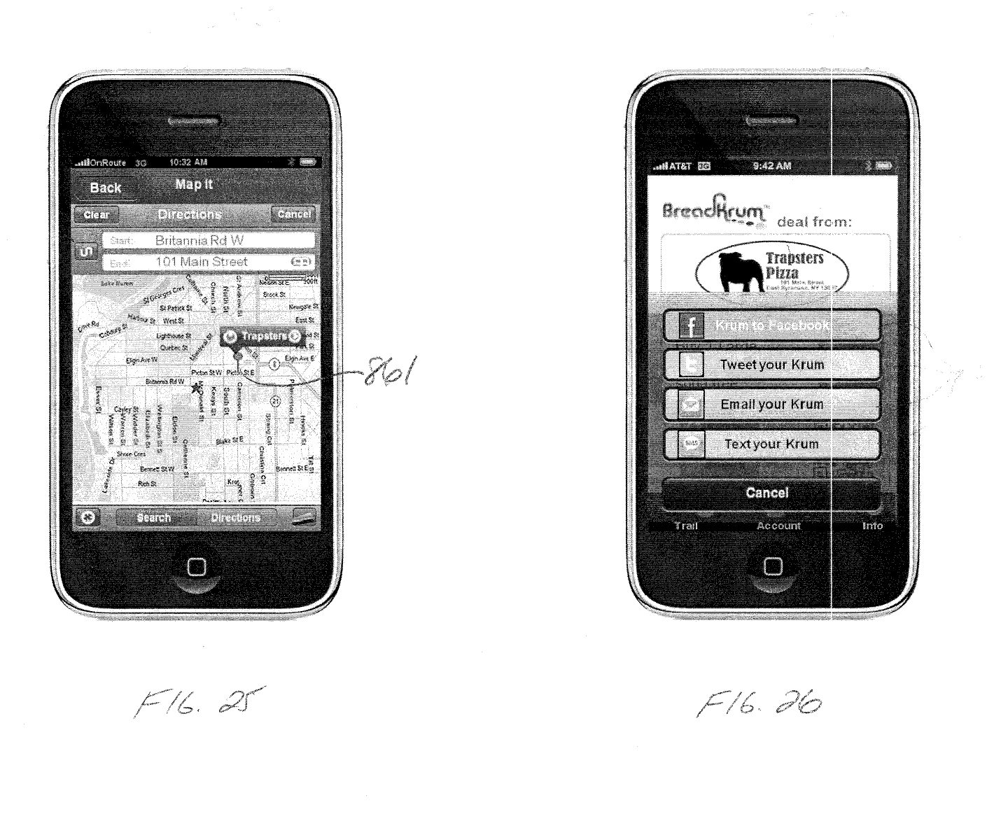

FIG. 23 is an exemplary display screen 840 on a mobile digital device showing the advertisement message electronically delivered to the mobile digital device in the exemplary advertising system 100 of FIG. 1. The advertisement message includes the banner 841 for the advertisement campaign, the advertising campaign description 842, as well as a web site link 843 to the URL electronically associated with the advertising campaign (shown in FIG. 24), and a direction link 844 to obtain directions to the advertiser (shown in FIG. 25). The advertisement message also includes a social network link 845 to share the message (shown in FIG. 26). The advertisement message also includes a QR code link 846 to enlarge the QR code for scanning by the user.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

A non-transitory computer readable signal medium may include a propagated data signal with computer readable program code embodied therein, for example, in baseband or as part of a carrier wave. Such a propagated signal may take any of a variety of forms and any suitable combination thereof. A computer readable signal medium may be any computer readable medium that is not a computer readable storage medium and that can communicate, propagate, or transport a program for use by or in connection with an instruction execution system, apparatus, or device.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. It will be understood that the disclosed exemplary methods can be performed in a different order or without all of the identified steps. In addition, the exemplary methods can be performed with additional steps. In addition, it will be understood that the disclosed system and method can be used for entities other than broadcast media or print publications. Such other examples are intended to be within the scope of the claims if they have structural elements that do not differ from the literal language of the claims, or if they include equivalent structural elements with insubstantial differences from the literal language of the claims.

What is claimed is:

1. A method for advertising, the method comprising steps of:
electronically defining a geographic advertising area for an advertisement vendor;
authorizing an advertisement vendor to sell advertisement messages to an advertiser located in the geographic advertising area; and
electronically delivering advertisement messages for the advertiser to a mobile digital devices in the geographic advertising area.

2. A method for advertising, the method comprising the steps of:
electronically identifying the geographic location of an advertiser;
electronically associating the advertiser with an advertising campaign;
electronically associating an advertising message with an advertising campaign; and
electronically delivering the advertisement messages for the advertiser to mobile digital devices when the mobile digital devices are within a predetermined distance of the geographic location of an advertiser.
